(19) United States
(12) Patent Application Publication
(10) Pub. No.: US 2021/0166285 A1
(43) Pub. Date: Jun. 3, 2021

(54) INFORMATION PROCESSING APPARATUS, INFORMATION PROCESSING METHOD, AND INFORMATION PROCESSING SYSTEM

(71) Applicant: SONY CORPORATION, Tokyo (JP)

(72) Inventor: Takumi YAJIMA, Tokyo (JP)

(73) Assignee: SONY CORPORATION, Tokyo (JP)

(21) Appl. No.: 17/263,386

(22) PCT Filed: May 7, 2019
(86) PCT No.: PCT/JP2019/018310

§ 371 Date: Jan. 26, 2021

(30) Foreign Application Priority Data
Aug. 2, 2018 (JP) 2018-146249

(51) Int. Cl. G06Q 30/06; G06F 3/0481; G06F 3/0484

(52) U.S. Cl. CPC G06Q 30/0603; G06F 3/0481; G06F 8/36; G06Q 30/0627; G06F 3/0484

(57) ABSTRACT

There is provided an information processing system that provides support for application development. The information processing system includes a selling apparatus and a buying apparatus. The selling apparatus registers, in a database, registration information including information regarding an input or output variable of a module, a function of the module, or an effect of the module, and performs processing related to the selling of the module. The buying apparatus performs processing related to a user's buying of a module. The selling apparatus searches the database for a module having a related module function, on the basis of product identification information inputted to the buying apparatus, and returns the result of the search to the buying apparatus. The buying apparatus presents, to the user, the module returned from the selling apparatus.

### TECHNICAL FIELD

A technology disclosed in this document relates to an information processing apparatus, an information processing method, and an information processing system that perform processing related to application development.

### BACKGROUND ART

Recently, applications are generally sold in an online marketplace. For example, a seller terminal uploads an application to an application selling site, and a buyer terminal downloads a desired application from the application selling site. Further, an application seller is able to receive the proceeds of sale of an application from the application selling site.

### CITATION LIST

### Patent Literature

### [PTL 1]

Japanese Patent Laid-open No. Hei 9-114651

### [PTL 2]

Japanese Patent Laid-open No. 2004-185103

### [PTL 3]

Japanese Patent Laid-open No. 2008-242613

### SUMMARY

### Technical Problem

An object of the technology disclosed in this document is to provide an information processing apparatus, an information processing method, and an information processing system that perform processing related to application development.

### Solution to Problem

According to a first aspect of the technology disclosed in this document, there is provided an information processing apparatus including a registration section and a search section. The registration section registers registration information in a database. The registration information includes information regarding at least one of an input variable of a module, an output variable of the module, a function of the module, or an effect of the module. The search section searches the database for a module having a related module function, on the basis of identification information regarding a product.

In the information processing apparatus according to the first aspect, the registration section registers, in the database, the registration information received from a first terminal of a seller of a module. Further, the search section performs a search in the database on the basis of the identification information regarding the product inputted to a second terminal of a buyer of a module and returns the result of the search to the second terminal. Further, the search section performs a search for candidate modules having a module function similar to a module function designated by the second terminal and presents the candidate modules to the second terminal.

In addition, the information processing apparatus according to the first aspect may additionally include a supply section, a testing section, and an optimization section. The supply section builds an application from a plurality of modules that is selected by the second terminal on the basis of the result of the search performed by the search section, and supplies the application to the second terminal. The testing section tests the operation of the application that is built from the plurality of modules selected by the second terminal. The optimization section optimizes the modules selected by the second terminal.

Further, according to a second aspect of the technology disclosed in this document, there is provided an information processing method including a registration step and a search step. The registration step registers registration information in a database. The registration information includes information regarding at least one of an input variable of a module, an output variable of the module, a function of the module, or an effect of the module. The search step searches the database for a module having a related module function on the basis of identification information regarding a product.

Further, according to a third aspect of the technology disclosed in this document, there is provided an information processing apparatus including an input section and a presentation section. The input section allows a user to input identification information regarding a product. The presentation section presents, to the user, a module that has a related module function and is searched for on the basis of the identification information regarding the product.

In the information processing apparatus according to the third aspect, the identification information regarding the product inputted to the input section is transmitted to an external apparatus, and the presentation section presents the module that has the related module function and is searched for by the external apparatus on the basis of the identification information regarding the product. Further, the presentation section presents candidate modules having a module function similar to a module function designated by the second terminal, the candidate modules being searched for by an external apparatus.

Moreover, according to a fourth aspect of the technology disclosed in this document, there is provided an information processing method including an input step and a presentation step. The input step allows a user to input identification information regarding a product. The presentation step presents, to the user, a module that has a related module function and is searched for on the basis of the identification information regarding the product.

Furthermore, according to a fifth aspect of the technology disclosed in this document, there is provided an information processing system including a selling apparatus and a buying apparatus. The selling apparatus registers registration information in a database and performs processing related to the selling of a module. The registration information includes information regarding at least one of an input variable of the module, an output variable of the module, a function of the module, or an effect of the module. The buying apparatus performs processing related to a user's buying of a module. The selling apparatus searches the database for a module having a related module function on the basis of identification information regarding a product inputted to the buying apparatus and returns the result of the search to the buying apparatus. The buying apparatus presents, to the user, the module returned from the selling apparatus.

It should be noted that the term “system” used in this document denotes a logical aggregate of a plurality of apparatuses (or functional modules implementing specific functions) and is applicable no matter whether or not the apparatuses and functional modules are within a single housing.

### Advantageous Effect of Invention

The technology disclosed in this document is able to provide an information processing apparatus, an information processing method, and an information processing system that perform processing related to application development.

It should be noted that effects described in this document are merely illustrative and not restrictive. The present invention is not limited to such described effects. Further, in some cases, the present invention may provide additional effects.

Other objects, features, and advantages of the technology disclosed in this document will be apparent from the following more detailed description based on a later-described embodiment and accompanying drawings.

### BRIEF DESCRIPTION OF DRAWINGS

FIG. 1 is a schematic diagram illustrating an example configuration of an online transaction system 100.

FIG. 2 is a diagram illustrating an example configuration of a camera system 200.

FIG. 3 is a flowchart illustrating a process that is performed by the camera system 200 to detect a person in a camera image and track the detected person.

FIG. 4 is a diagram illustrating a procedure of developing an application that detects a person in a camera image and tracks the detected person.

FIG. 5 is a diagram illustrating an example of a processing sequence that is performed between a buyer terminal 102 and a module selling site 103 at the time of application development.

FIG. 6 is a diagram illustrating an example of module registration information that is to be stored in a module registration information database 104.

FIG. 7 is a diagram illustrating Sub-class candidates for object recognition.

FIG. 8 is a diagram illustrating Target candidates for object recognition.

FIG. 9 is a diagram illustrating an input interface, an output interface, and a target that are related to each Sub-class included in a Class named “object recognition.”

FIG. 10 is a diagram illustrating a visualized example of a ROS (Robot Operating System) module and input/output interface (an example of a module having an input and an output).

FIG. 11 is a diagram illustrating a visualized example of the ROS module and input/output interface (an example of a module generating an output only).

FIG. 12 is a diagram illustrating a visualized example of the ROS module and input/output interface (an example of a module having an input only).

FIG. 13 is a diagram illustrating a procedure of searching for a module during application development.

FIG. 14 is a diagram illustrating a procedure of searching for a module.

FIG. 15 is a diagram illustrating a procedure of searching for a module.

FIG. 16 is a diagram illustrating a procedure of searching for a module.

FIG. 17 is a diagram illustrating a procedure of searching for a module.

FIG. 18 is a diagram illustrating a module search screen to which a module is added through a module search.

FIG. 19 is a diagram illustrating a procedure of searching for a module.

FIG. 20 is a diagram illustrating a procedure of searching for a module.

FIG. 21 is a diagram illustrating a procedure of searching for a module.

FIG. 22 is a diagram illustrating a procedure of searching for a module.

FIG. 23 is a diagram illustrating a procedure of searching for a module.

FIG. 24 is a diagram illustrating the flow of module simulation and operational testing in the online transaction system 100 (a case where test data is used).

FIG. 25 is a diagram illustrating the flow of module simulation and operational testing in the online transaction system 100 (a case where a module is tested on an actual machine).

FIG. 26 is a diagram illustrating the flow of module simulation and operational testing in the online transaction system 100 (a case where simulation is performed for testing purposes).

FIG. 27 is a diagram illustrating an example extension of the online transaction system 100.

### DESCRIPTION OF EMBODIMENT

An embodiment of a technology disclosed in this document will now be described in detail with reference to the accompanying drawings.

In general, applications each include one or more modules (or algorithms). In some cases, the functions of a certain module included in an application may be changed. After a download sale of the application, the entire application can be updated to apply function changes.

However, no scheme is yet available for selecting a certain module as a development target, changing the functions of the target module, and delivering the target module through an online marketplace. Further, although the applications can easily be searched for based, for example, on their uses or selling agencies, the modules each have a configuration that varies from one developer to another, and involve the use of different languages. Therefore, under existing conditions, the modules cannot easily be searched for.

For example, in recent years, a deep learning technology is utilized in an increasing number of situations due to a rapid spread of an AI (Artificial Intelligence) technology. Learned models generated by deep learning are developed on an individual module basis in an increasing number of situations and are frequently updated. Therefore, great benefits are obtained when such modules can be handled as a transaction target in an online marketplace.

There has been proposed, for example, a method that is applied at the time of changing a specific module within a program in order to easily confirm whether a variable used by the specific module is also used by another module (refer to PTL 1). However, a method of inputting a product ID to search for a module available as a substitute for a currently mounted module is not disclosed.

Further, there has been proposed a method of easily extracting data from a database without any knowledge of programming (refer to PTL 2). However, the method of inputting a product ID to search for a module available as a substitute for a currently mounted module is not disclosed.

Furthermore, there has been proposed a program development support system that manages various types of functions generated in a similar manner and makes it easy to reuse the functions without knowledge of their names (refer to PTL 3). However, the method of inputting a product ID to search for a module available as a substitute for a currently mounted module is not disclosed.

In view of the above circumstances, this document makes the following proposal regarding a technology for appropriately handling a module, that is, a component of an application, as a transaction target, for example, in an online marketplace.

### A. System Configuration

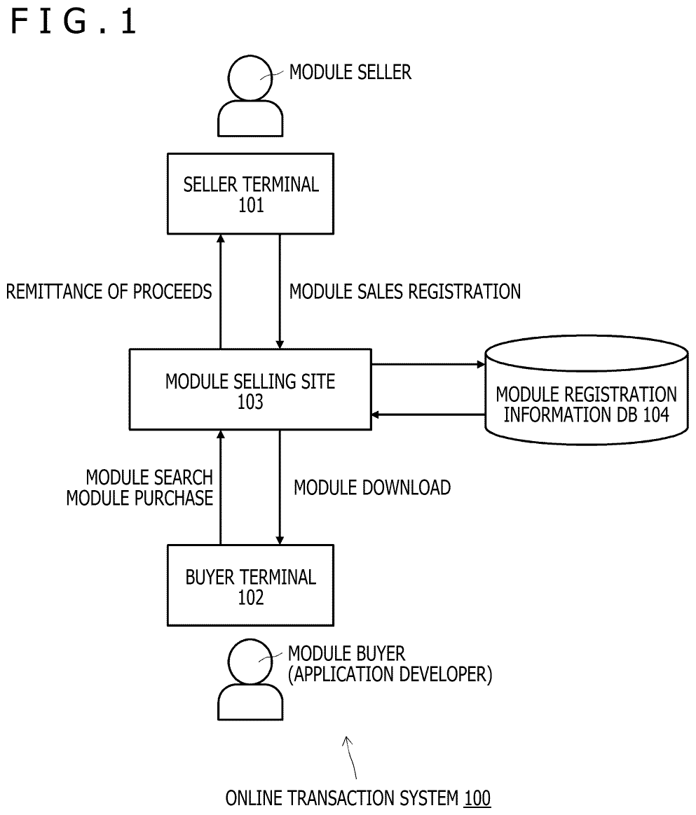

FIG. 1 schematically illustrates an example configuration of an online transaction system 100 for providing online transaction of software on an individual module basis, the module being a component of an application. The online transaction system 100 depicted in FIG. 1 includes a seller terminal 101, a buyer terminal 102, a module selling site 103, and a module registration information database 104. It is assumed that the respective apparatuses 101 to 104 are interconnected through a wide area network such as the Internet.

The seller terminal 101 is a terminal apparatus (e.g., a PC, a tablet terminal, or a smartphone) operated by a module seller. Meanwhile, the buyer terminal 102 is a terminal apparatus (e.g., a PC, a tablet terminal, or a smartphone) operated by a module buyer. The module selling site 103 serves as an intermediary between the seller terminal 101 and the buyer terminal 102 and manages the online transaction of a module. Further, the module registration information database 104 stores registration information regarding each module traded on the module selling site 103.

Here, the term “module” denotes a module having a data structure that prescribes the input and output of a specific algorithm and permits data to be stored in a database.

The module seller establishes connection from the module seller's seller terminal 101 to the module selling site 103 through the Internet and performs module sales registration. More specifically, the module seller inputs, from its seller terminal 101, module registration information such as the input or output variable of a module for sale on the module selling site 103, the function of the module, the effect of the module, and product identification information (in a case where the module is dependent on a specific product). The module selling site 103 then registers the module registration information inputted from the seller terminal 101, in the module registration information database 104.

Further, when a module registered on the module selling site 103 is bought by a buyer (or a bought module is downloaded to the buyer terminal 102), the module seller is able to receive the proceeds of sale of the module from the module selling site 103.

The module buyer is able to establish connection from the module buyer's buyer terminal 102 to the module selling site 103 through the Internet and search for a module registered in the module registration information database 104, on the basis of the module registration information such as the input or output variable of the module, the function of the module, the effect of the module, and the product identification information (in a case where the module is dependent on a specific product). The module buyer then performs a procedure of buying a desired module from the module buyer's buyer terminal 102 and downloads the bought module to the buyer terminal 102.

When a module is bought or downloaded to the buyer terminal 102, the module selling site 103 performs a process of charging a buyer or its buyer terminal 102 for the module. However, the charging process will not be described in detail.

The module buyer is able to develop an application for specific use by combining a plurality of modules downloaded to the module buyer's buyer terminal 102. A user of the buyer terminal 102 is not only a module buyer but also an application developer.

It should be noted that, for simplicity of drawings, FIG. 1 depicts only one seller terminal 101 and only one buyer terminal 102. However, it is conceivable that a plurality of module sellers may perform sales registration and sales of modules through one module selling site 103 and that a plurality of buyers may buy and download modules.

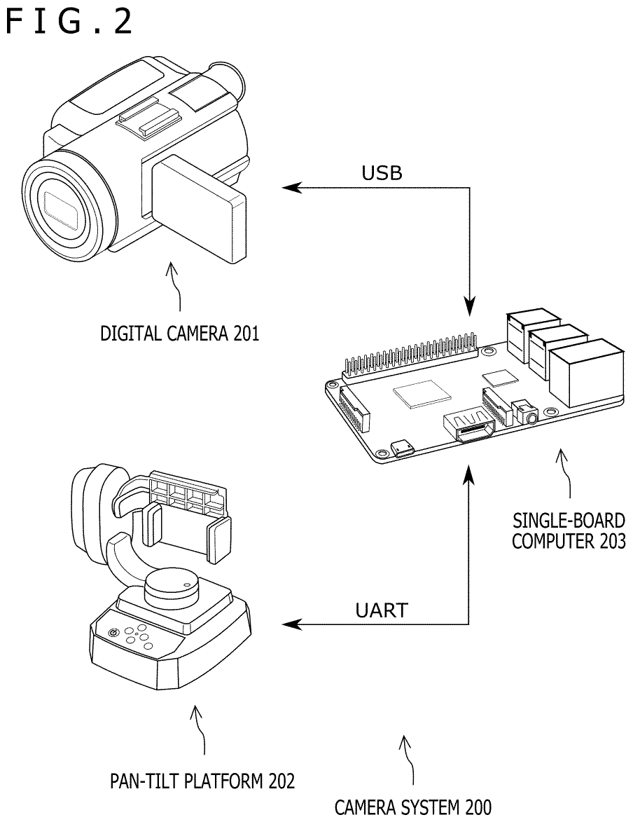

Now, a case where the online transaction system 100 depicted in FIG. 1 is used to develop an application for specific use will be described. Here, the application is adapted to detect a person in a camera image and track the detected person by using a camera system 200 having a hardware configuration formed by combining a digital camera 201, a pan-tilt platform 202, and a single-board computer 203 depicted in FIG. 2. The digital camera 201 is mounted on the pan-tilt platform 202, which pans and tilts. The single-board computer 203 is able to process the camera image and exercise drive control over the pan-tilt platform 202.

It should be noted that the single-board computer 203 in the camera system 200 having the hardware configuration depicted in FIG. 2 may be, for example, a “Raspberry Pi (raspi)” including an ARM processor.

Further, it is assumed that, for example, a USB (Universal Serial Bus) is connected between the digital camera 201 and the single-board computer 203 while a UART (Universal Asynchronous Receiver/Transmitter) is connected between the pan-tilt platform 202 and the single-board computer 203.

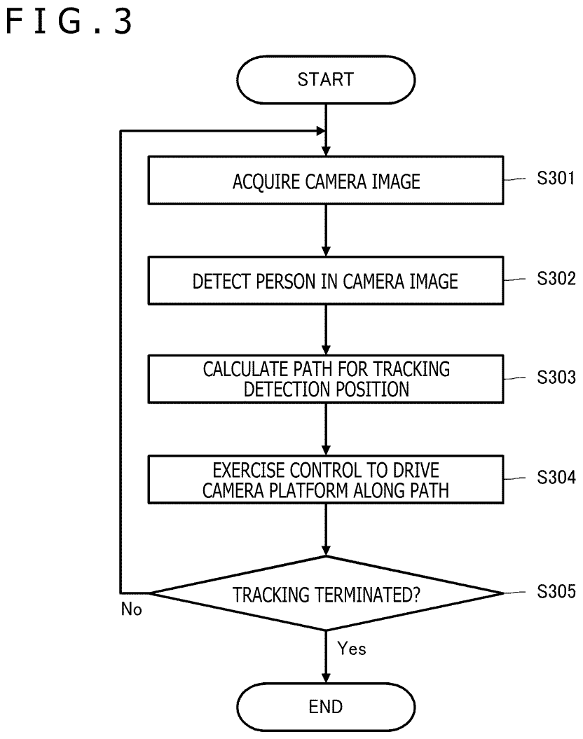

In order to detect a person in a camera image and track the detected person, the camera system 200 needs to perform a process depicted, for example, in the flowchart of FIG. 3. More specifically, the camera system 200 needs to acquire an image captured by the digital camera 201 (step S301), detect a person in the captured image (step S302), calculate a path for tracking a position where the person is detected (step S303), and drive the pan-tilt platform 202 along the calculated path (step S304). Additionally, steps S301 to S304 are repeatedly performed until the end of tracking (“NO” at step S305).

Consequently, it is obvious that the following respective modules are required to develop an application for use in the camera system 200 for the purpose of detecting a person in a camera image and tracking the detected person.

The required modules are described below.

(a) A module that performs a process of acquiring an image from the digital camera 201.

(b) A module that performs a process of detecting a person in an image.

(c) A module that performs a process of calculating a path for tracking a position where the person is detected in the image.

(d) A module that performs a process of driving the pan-tilt platform 202 along a predetermined path.

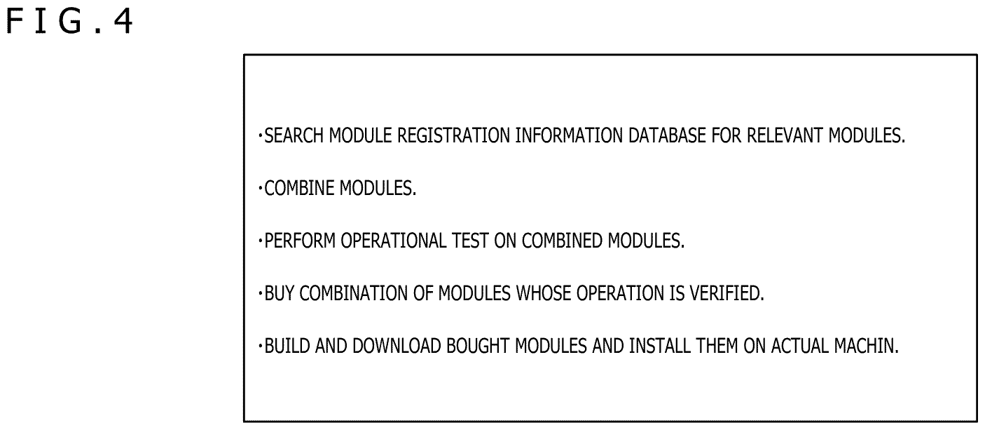

The application developer operates its buyer terminal 102 so as to search the module registration information database 104 for the above-mentioned modules (a) to (d) by using the module registration information, combine the modules (a) to (d), perform an operational test on the resulting module combination, buy the modules (a) to (d) on the basis of the results of the operational test, build and download the modules (a) to (d), and install the modules (a) to (d) on an actual machine of the camera system 200 to make the application available. The above-described application development procedure is summarized in FIG. 4.

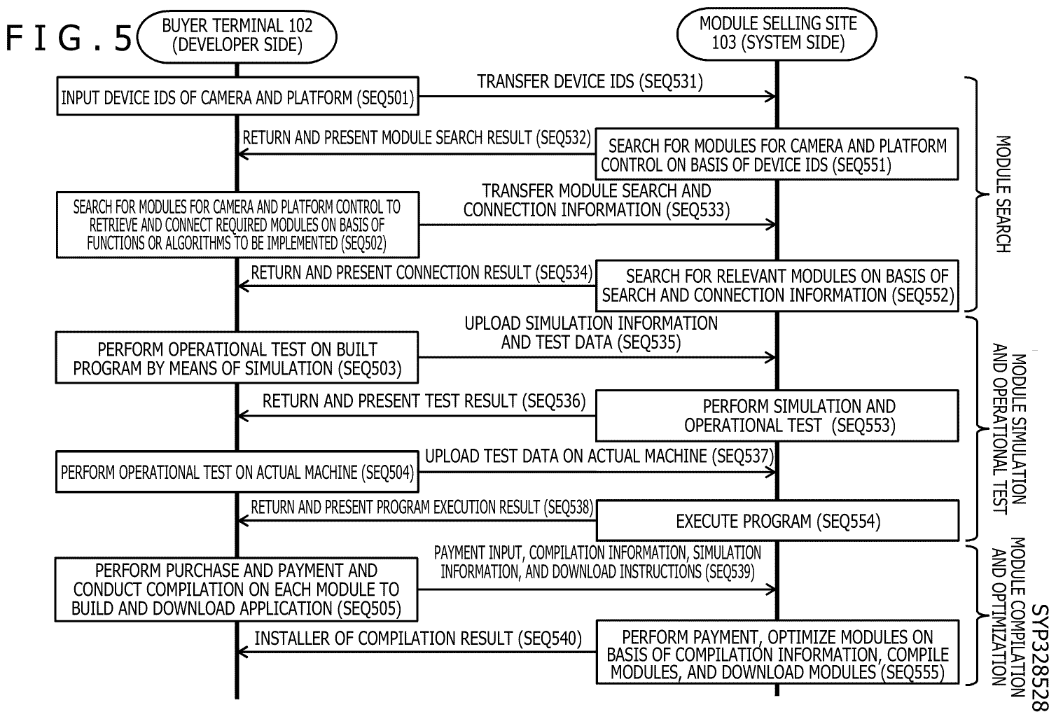

FIG. 5 is a diagram illustrating an example of a processing sequence that is performed between the buyer terminal 102 and the module selling site 103 at the time of developing an application for use in the camera system 200 for detecting a person in a camera image and tracking the detected person. It is assumed that the information regarding the modules to be sold is registered in the module registration information database 104 before the start of the illustrated processing sequence. Further, in the illustrated processing sequence, respective phases named “module search,” “module simulation and operational testing,” and “module optimization and compilation” are performed in sequence.

The application developer uses its buyer terminal 102 to input the device IDs of the digital camera 201 and pan-tilt platform 202 (SEQ501). Information regarding each inputted device ID is transferred from the buyer terminal 102 to the module selling site 103 (SEQ531). In this above instance, a user may input the device IDs to the buyer terminal 102 by using a keyboard or other input apparatuses. Alternatively, the buyer terminal 102 may automatically read the information regarding each device ID from the digital camera 201 and pan-tilt platform 202 that are connected through a USB, Bluetooth (registered trademark), or other wired or wireless communication links. In a case where the buyer terminal 102 and devices connected to the buyer terminal 102 both have a noncontact reader/writer function, the buyer terminal 102 may read the IDs from the devices by noncontact communication.

The module selling site 103 searches the module registration information database 104 on the basis of the device IDs received from the buyer terminal 102, for the purpose of retrieving modules for controlling the digital camera 201 and the pan-tilt platform 202 (SEQ551), returns the result of such a module search to the buyer terminal 102 (SEQ532), and presents the module search result to the application developer through the buyer terminal 102 (e.g., displays the module search result on a “module search screen” (described later)).

By using the buyer terminal 102, the application developer performs a search on the respective modules for controlling the digital camera 201 and the pan-tilt platform 202, retrieves required modules on the basis of the functions or algorithms to be implemented, and attempts to connect the modules (SEQ502).

In the above instance, search and connection information regarding the modules is transferred from the buyer terminal 102 to the module selling site 103 (SEQ533). On the basis of the search and connection information regarding the modules which is received from the buyer terminal 102, the module selling site 103 searches the module registration information database 104 for the corresponding modules (SEQ552). Then, the module selling site 103 returns the result of the search to the buyer terminal 102 (SEQ534) and allows the buyer terminal 102 to present the search result to the application developer (e.g., displays the search result on the module search screen). The module search phase is as described above.

The above-described processing sequence is repeated multiple times as needed to search for the modules and connect the modules to each other. As a result of the connection of the plurality of modules searched for and retrieved, a program (an application for detecting a person in a camera image and tracking the detected person) is assembled on the online transaction system 100 (hereinafter referred to as “built”). Next, the application developer performs an operational test on the built program by means of simulation (SEQ503).

In the above instance, the buyer terminal 102 is used by the application developer in order to input and set simulation information, and then, test data and the inputted and set simulation information are uploaded from the buyer terminal 102 to the module selling site 103 (SEQ535).

The module selling site 103 performs the operational test on the built program by means of simulation (SEQ553) on the basis of the test data uploaded from the buyer terminal 102, returns the result of the operational test to the buyer terminal 102 (SEQ536), and allows the buyer terminal 102 to present the operational test result to the application developer (e.g., displays the operational test result on the module search screen).

Next, the actual machine of the camera system 200 also performs an operational test on the built program (SEQ504). Then, the test data on the actual machine is uploaded from the buyer terminal 102 to the module selling site 103 (SEQ537).

The module selling site 103 executes the program on the basis of the test data on the actual machine which is uploaded from the buyer terminal 102 (SEQ554), returns the result of the program execution to the buyer terminal 102 (SEQ538), and allows the buyer terminal 102 to present the program execution result to the application developer (e.g., displays the program execution result on the module search screen). The module simulation and operational testing phase are as described above.

Subsequently, the application developer buys each module by performing a payment process on each module to be bought, with respect to the module selling site 103 by using the buyer terminal 102, conducts compilation on an individual module basis to build an application, and performs a download procedure (SEQ505).

In the above instance, payment input information, compilation information (e.g., the device ID of the single-board computer 203), and download instructions are transmitted from the buyer terminal 102 to the module selling site 103 (SEQ539).

The module selling site 103 performs a payment process based on payment information received from the buyer terminal 102, optimizes the modules on the basis of the compilation information, compiles the modules, and downloads the compiled modules to the buyer terminal 102 (SEQ555). Then, from the buyer terminal 102, an installer installs the result of compilation on the actual machine of the camera system 200 (SEQ540). The module compilation and optimization phase are as described above.

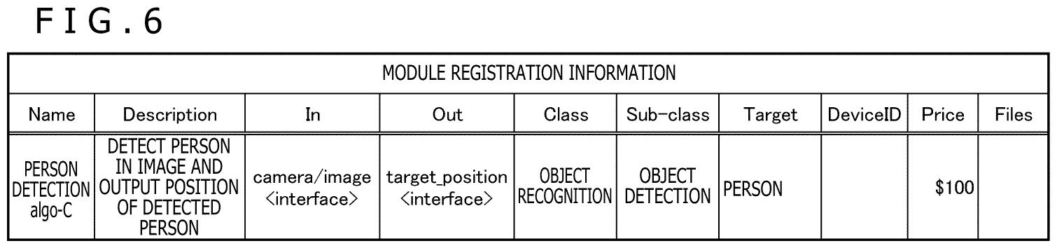

FIG. 6 illustrates an example of module registration information that is to be stored in the module registration information database 104. The example illustrated in FIG. 6 is the module registration information regarding a “person detection algo-C” module for detecting a person in a camera image.

An input of the person detection algo-C module, which is expressed by a camera/image interface, indicates an input of an image from a camera. For example, in a case where the image to be inputted is such that R, G, and B color signals are each expressed in 8-bit gradation, a ROS interface definition of a camera/image is as described below.
camera/image
   int8 r
   int8 g
   int8 b

Further, an output of the person detection algo-C module, which is expressed by a target_position interface, indicates the output of the position of a person who is detected from a captured image inputted from a camera. FIG. 6 illustrates the registration information regarding such a module that is expressed according to the notation of a ROS for supplying libraries and tools providing support for the creation of a robot application, and is then visualized. In module sales registration, the module seller uses its seller terminal 101 to input and register the module registration information depicted in FIG. 6 in the module registration information database 104.

Within the depicted module registration information, “Name” indicates the name of a module, “Description” gives an overview of the module, “In” indicates an input variable name of the module, “Out” indicates an output variable name of the module, “Class” indicates a common name of an algorithm, “Sub-class” indicates the purpose and use of the algorithm (this may be allowed to be registered as the common name), “Target” indicates what is targeted by the algorithm (there may be no “Target” depending on the algorithm), “Device ID” indicates whether the algorithm is dependent on a specific device or product (or indicates the identification information regarding a device or product compliant with the algorithm), and “Price” indicates the selling price of the algorithm. Incidentally, it can be said that the functionality of the algorithm is expressed by a combination of “Class,” “Sub-class,” and “Target” (or expressed by only one of these).

Under “Files,” the entity of the module is registered. As far as it is in a format such as an object code, source code, or neural network format, for example, network configuration files and learned weight parameters are registered. Incidentally, it is conceivable that the learned models generated by deep learning will be developed on an individual module basis in an increasing number of situations and will frequently be updated.

Next, “Class,” “Sub-class,” and “Target” will be described with the examples thereof.

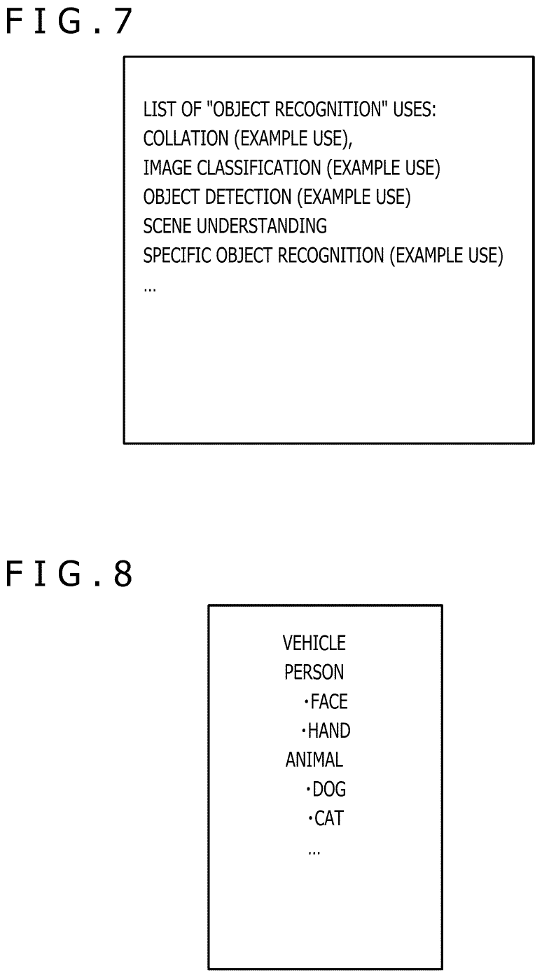

Here, the common name (Class) of an algorithm is registered as object recognition. As indicated by “sub-class candidate for object recognition,” there are some types of algorithms for object recognition. “Sub-class” indicates the type of algorithm. Referring to the example of FIG. 6, it is conceivable that a certain algorithm may belong to a plurality of Sub-classes although one Sub-class exists and that a certain other algorithm may have a deep Sub-class hierarchy. In the former case, there may be a plurality of elements, for example, in a Sub-class cell. Meanwhile, in the latter case, Sub-class-1, Sub-class-2, or other new columns may be added to the registration information. FIG. 7 illustrates Sub-class candidates for object recognition.

In a case where object recognition is selected here, it is necessary to define what to detect. Relevant candidates are indicated under “Target candidates for object recognition.” In some cases, a plurality of Targets is indicated. In such cases, a plurality of elements may be included in a Target cell. FIG. 8 illustrates the Target candidates for object recognition.

Such equipment as a camera, a motor, or a sensor is assumed as a device or product indicated under “Device ID.”

It should be noted that, in a case where “object recognition” is designated as “Class,” which is a common name of an algorithm, the Sub-class candidates for “object recognition” may be, for example, “collation,” “image classification,” “object detection,” “scene understanding,” and “specific object recognition,” as depicted in FIG. 7, depending on the purpose and use of the algorithm. The input variable, the output variable, and the target (“target”) vary from one Sub-class to another, that is, vary depending on the purpose and use of the algorithm.

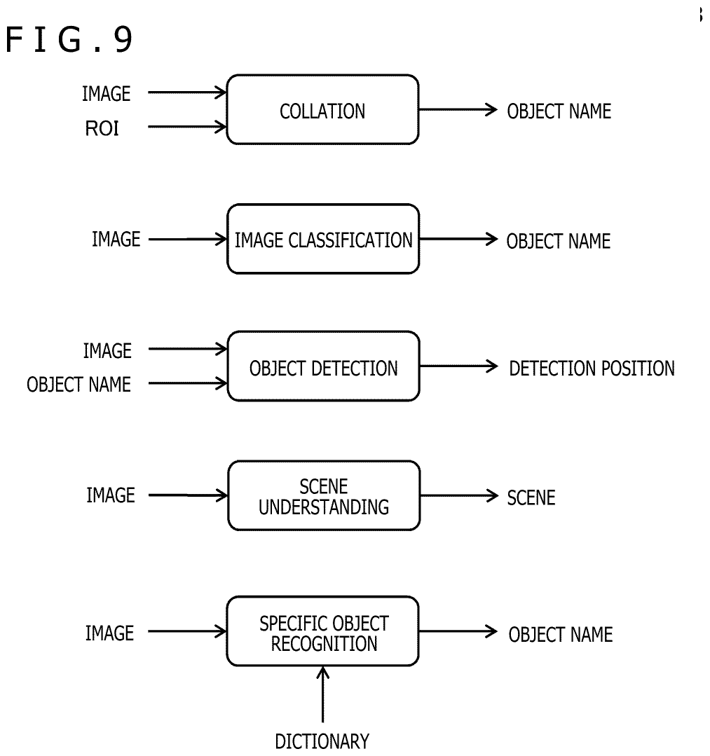

FIG. 9 depicts the input variable, output variable, and target regarding each of Sub-classes included in a Class named “object recognition,” that is, “collation,” “image classification,” “object detection,” “scene understanding,” and “specific object recognition.”

When an image is inputted and an ROI (Region Of Interest) in the inputted image is designated as the “target,” a module in the Sub-class “collation” outputs the object name of the ROI in the inputted image. Further, a module in the Sub-class “image classification” uses an image as an input and outputs the object name of an object included in the inputted image. In addition, when an image is inputted and “target” is designated as the object name, a module in the Sub-class “object detection” detects an object having the designated object name in the inputted image and outputs a detection position where the object is detected. A “person detection algo-C” module is a module in the Sub-class “object detection.” However, as indicated by the registration information depicted in FIG. 6, the “person detection algo-C” module uses a camera image as an input, designates a person as the “target,” detects a person in the inputted camera image, and outputs the position of the detected person. Moreover, a module in the Sub-class “scene understanding” uses an image as an input and outputs a scene understood from the inputted image. Furthermore, a module in the Sub-class “specific object recognition” uses an image as an input, refers to a dictionary as needed, and outputs the object name of an object included in the inputted image.

### B. Module Search

A module search, which is a part of application development, will now be described. It should be noted, however, that the notation of the ROS will be used as needed for explanation purposes.

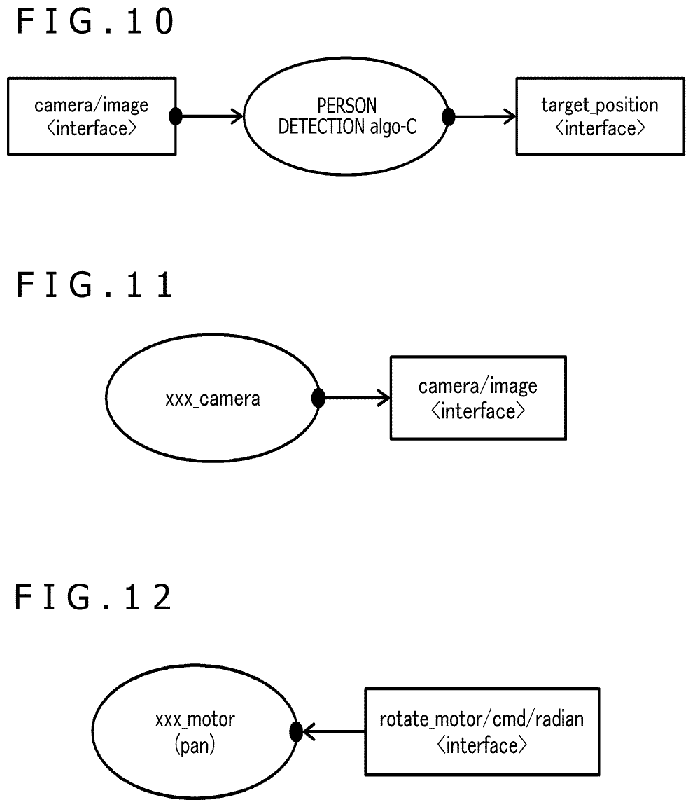

FIGS. 10 to 12 each illustrate a visualized example of a ROS module and input/output interface.

FIG. 10 illustrates a person detection algo-C module and its input/output interface as an example of a ROS module having an input and an output.

An input of the person detection algo-C module, which is expressed by a camera/image interface, indicates an input of an image from a camera. Meanwhile, an output of the person detection algo-C module, which is expressed by a target_position interface, indicates an output of the position of a person detected in a camera image. It should be noted that the registration information regarding the person detection algo-C module is as depicted in FIG. 6. More specifically, FIG. 6 indicates that Class is “object recognition” while Sub-class is “object detection” and that the input is expressed by the camera/image interface while the output is expressed by the target_position interface. A module handling a device having an input and an output (a device for inputting data and outputting the result of processing of the inputted data) belongs to this type.

Further, FIG. 11 illustrates an xxx_camera module and its output interface as an example of a ROS module generating an output only. As depicted in FIG. 11, the xxx_camera module is a module for outputting information captured by a camera as a camera/image. A module handling a sensor device or other input devices generating an output only belongs to this type.

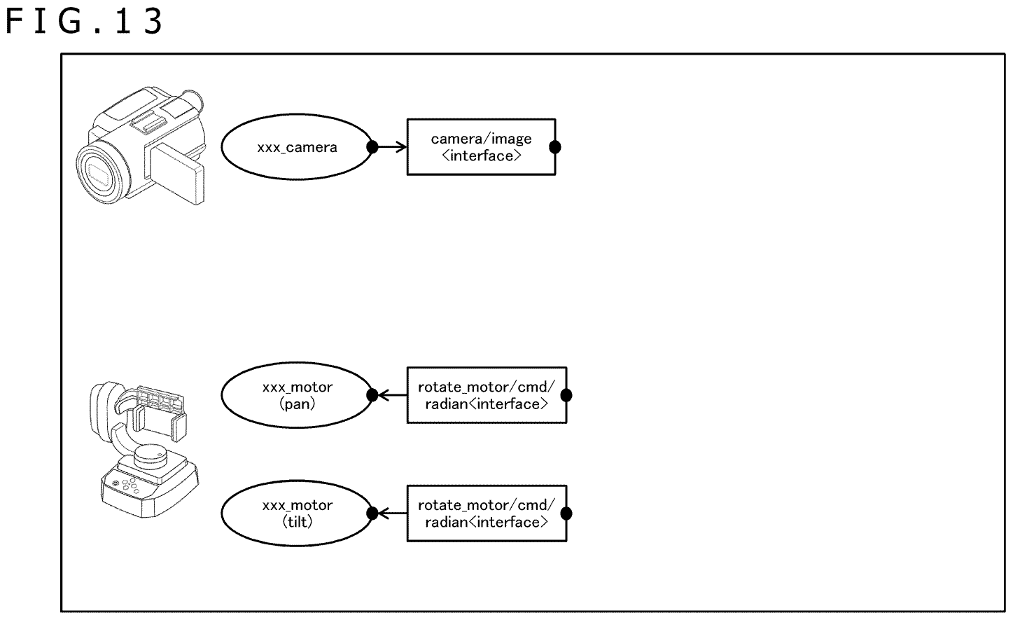

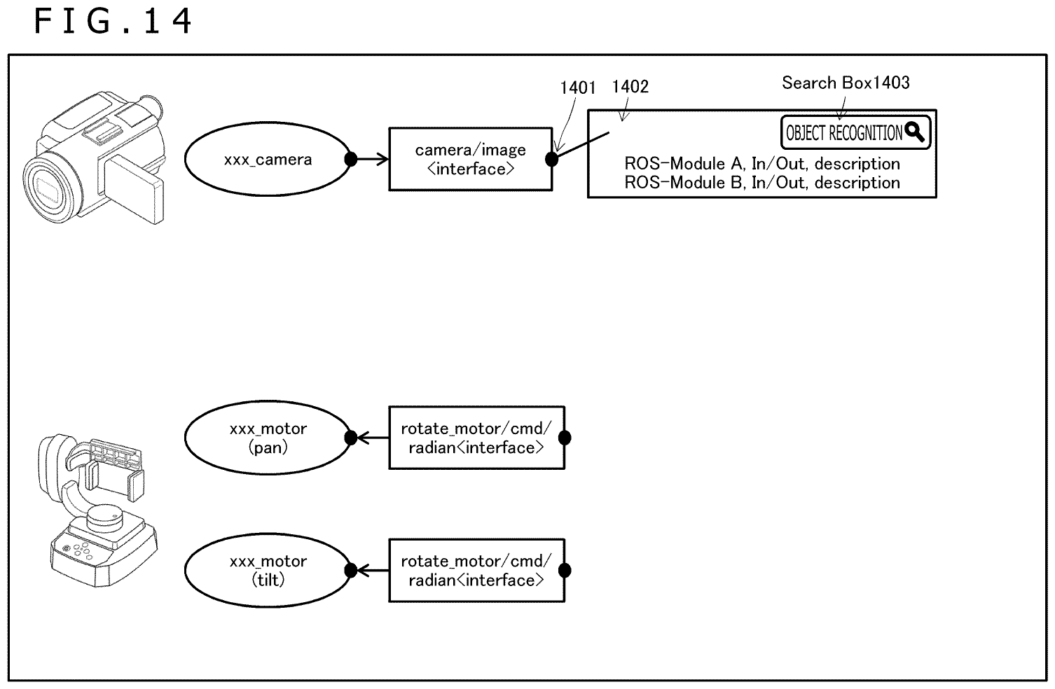

Further, FIG. 12 illustrates an xxx_motor module (rotating in a pan direction only) and its input interface as an example of a ROS module performing an input operation only. As depicted in FIG. 12, the xxx_motor module is a module for controlling a motor so as to rotate it in the pan direction on the basis of inputted rotate_motor/cmd/radian. A module handling a motor, a display, or other devices receiving an input only belongs to this type.

Here, a concrete procedure for performing a module search will be described with reference to FIGS. 13 to 22. The description given below deals with a case where a system (application) for detecting a person in a camera image and tracking the detected person is to be developed.

First of all, when a buyer developing an application designates the digital camera 201 and the pan-tilt platform 202 as target devices from the module search screen, information identifying a product (i.e., product identification information) is inputted to the module selling site 103, and then, a corresponding module is selected. The module selling site 103 is able to read the registration information regarding the selected module as needed from the module registration information database 104.

To achieve the input of the product identification information, that is, the designation of a device, it is only required to input the information identifying the product to the buyer terminal 102 in some form or any other form. For example, the product identification information may be inputted by reading the ID of a target product connected to the buyer terminal 102, by inputting the ID from the module search screen of the buyer terminal 102, or by inputting the ID in a noncontact manner through the use of NFC (Near Field Communication) or the like. As an alternative, the buyer may select a device by inputting a search keyword, such as the digital camera 201, the pan-tilt platform 202, or other common device names or a category, to the buyer's buyer terminal 102.

Referring to the example depicted in FIG. 13, when the buyer, that is, the application developer, inputs identification information identifying the digital camera 201 and identification information identifying the pan-tilt platform 202, the module search screen of the buyer terminal 102 displays respective icons of the digital camera 201 and pan-tilt platform 202 identified on the basis of the identification information. Further, the module selling site 103 searches the module registration information database 104 and outputs, to a screen, modules individually corresponding to the digital camera 201 and the pan-tilt platform 202, that is, xxx_camera, xxx_motor (pan), and xxx_motor (tilt). Additionally, an output interface for the xxx_camera module (camera/image<interface>) and respective input interfaces for the xxx_motor (pan) module and the xxx_motor (tilt) module (rotate_motor/cmd/radian<interface>) are outputted to the screen.

A procedure for performing an additional module search after the determination of modules acting as contacts between devices will now be described with reference to FIGS. 14 to 17.

The buyer clicks the output end of the camera/image interface, which is denoted by a reference numeral 1401 in FIG. 14, on the module search screen of the buyer terminal 102. When such a click operation is reported from the buyer terminal 102, the module selling site 103 searches the module registration information database 104 for modules connectable to the camera/image interface (or modules whose input is expressed by the camera/image interface). The module registration information database 104 can be searched for modules having an input variable common to the output variable of the xxx_camera module already searched for. The result of such a database search is displayed on the module search screen of the buyer terminal 102 as indicated by a reference numeral 1402.

In the above instance, the buyer indicates the purpose of current application development (or a Class name) by inputting “object recognition” in the Search Box denoted by a reference numeral 1403.

When “object recognition” inputted as the purpose by the buyer is reported from the buyer terminal 102, the module selling site 103 searches the module registration information database 104 for modules that are connectable to the camera/image interface (or modules whose output is expressed by the camera/image interface) and are Sub-class (or use) modules in the Class “object recognition.” In such an instance, the degree of similarity is also determined to search for similar modules.

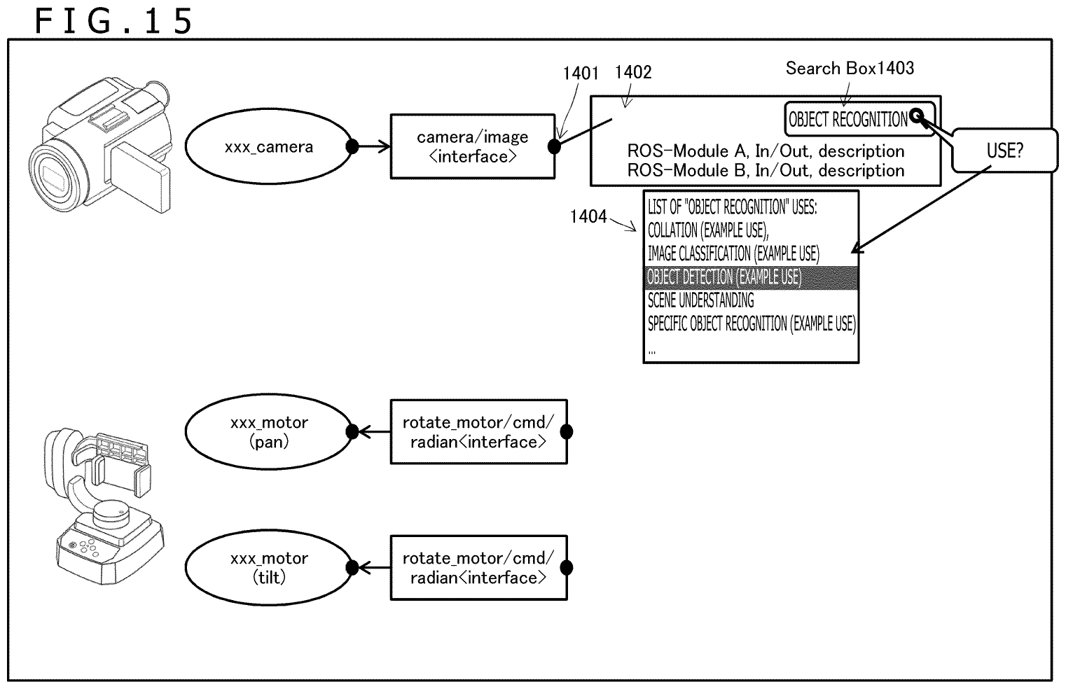

It should be noted that, in a case where many candidates belong to the Class designated by the buyer, the module selling site 103 addresses inquiries to the buyer through the buyer terminal 102 for purposes of narrowing down. In the example depicted in FIG. 15, the module selling site 103 displays not only a text or voice message “What will object recognition be used for?” but also a list of object recognition sub-classes as a list of uses as indicated by a reference numeral 1404. The buyer is able to select one or more sub-classes from the list of object recognition sub-classes 1404. In the example depicted in FIG. 15, the buyer selects “object detection” from the list of sub-classes 1404.

When the buyer's selection of the sub-class “object detection” is reported from the buyer terminal 102, the module selling site 103 searches the module registration information database 104 for modules that are connectable to the camera/image interface (or modules whose input is expressed by the camera/image interface) and provided with “object recognition” in Class and with “object detection” in sub-class. Then, the result of such a database search is displayed on the module search screen of the buyer terminal 102.

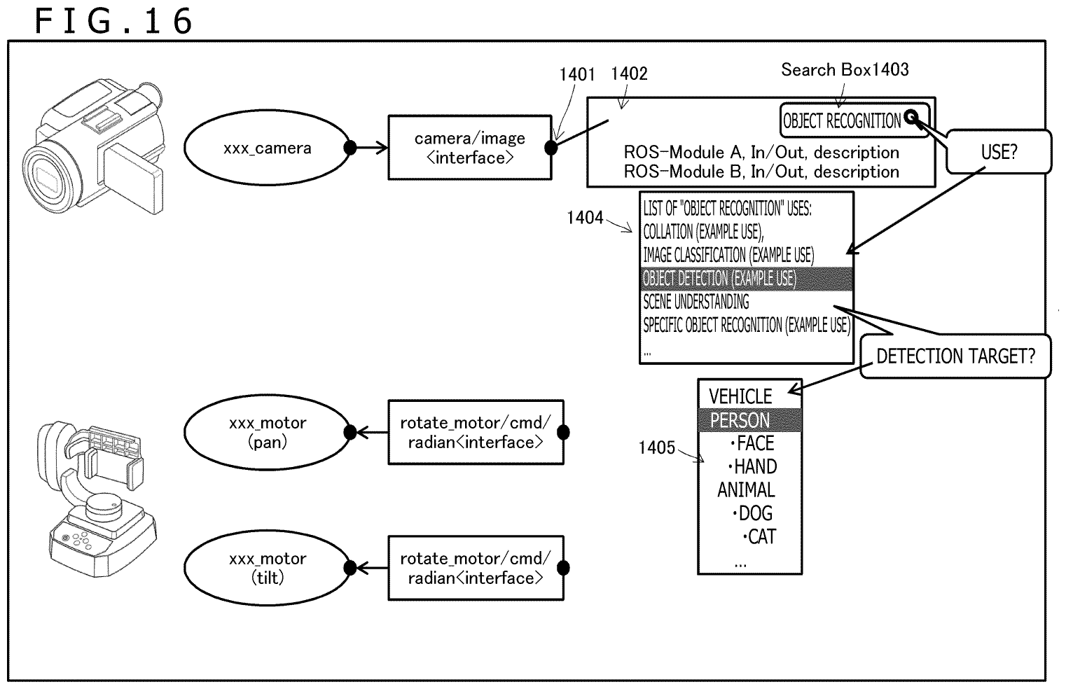

In a case where many candidates still belong to the Class and sub-class designated by the buyer, in order to narrow down the number of candidates targeted for “object detection,” the module selling site 103 displays, as depicted in FIG. 16, not only a text or voice message “What is to be detected?” but also a list of detection targets (Target) as indicated by a reference numeral 1405. The buyer is able to select one or more detection targets from the list of detection targets (Target) 1405. In the example depicted in FIG. 16, the buyer selects “person” from the list of detection targets (Target) 1405.

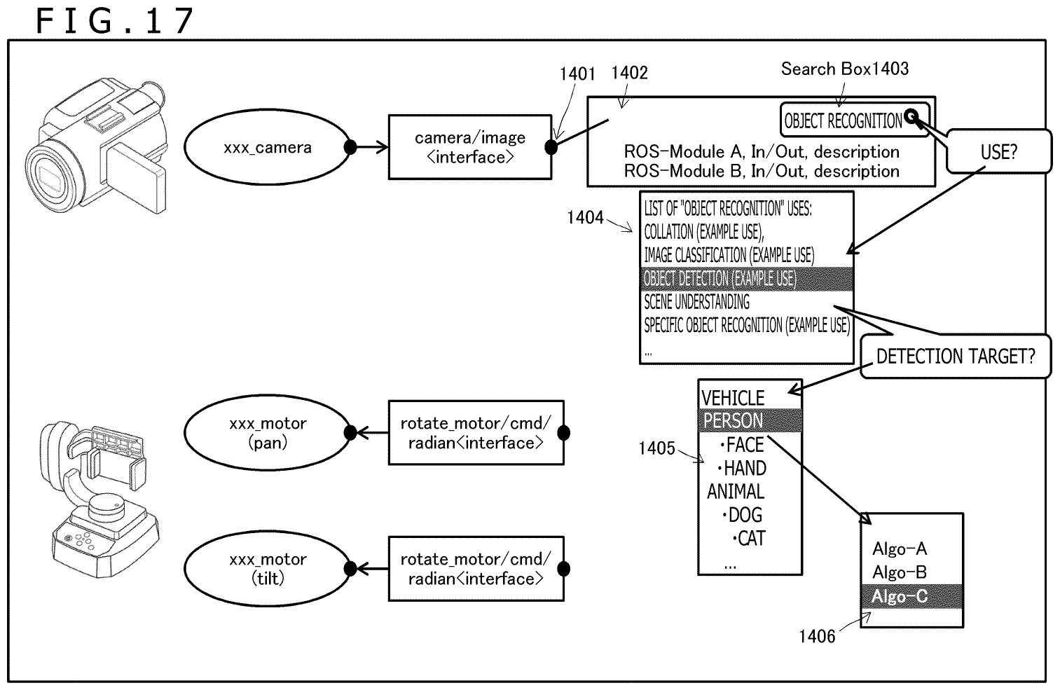

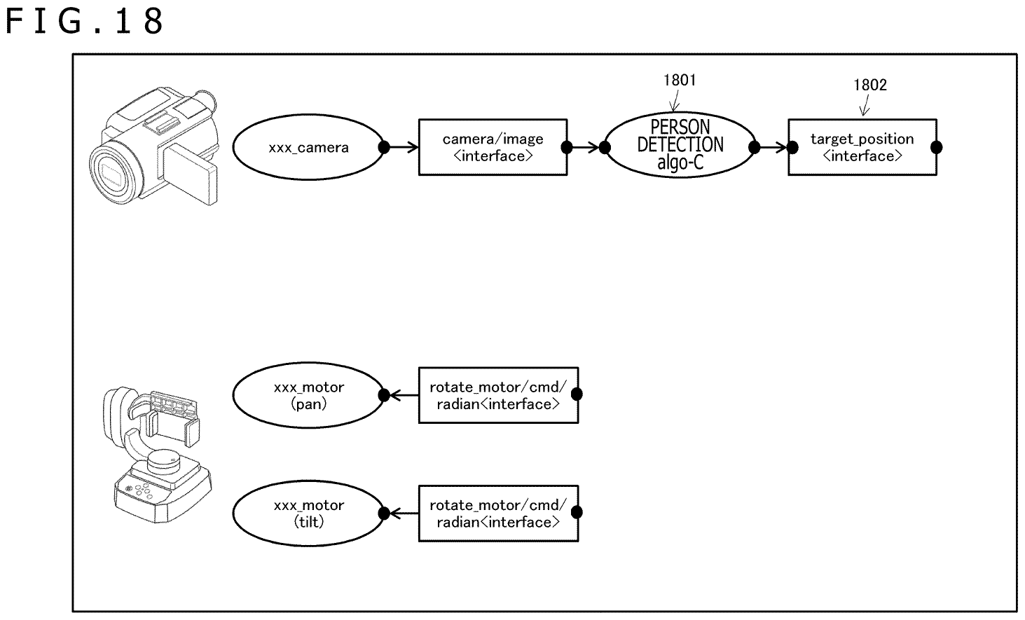

The module selling site 103 searches the module registration information database 104 for modules that are connectable to the camera/image interface (or modules whose input is expressed by the camera/image interface) and are provided with “object recognition” in Class, with “object detection” in sub-class, and with “person” in Target. Then, as indicated by a reference numeral 1406 in FIG. 17, a list of modules retrieved by the search of the module registration information database 104 is displayed on the module search screen of the buyer terminal 102. The buyer is able to select one or more modules from a module list 1406. In the example depicted in FIG. 17, the buyer selects a “(person detection) algo-C” module from the module list 1406.

In a case where many candidates still belong to the Class, sub-class, and Targer designated by the buyer and the module registration information database 104 stores information regarding user review evaluations, results of evaluation, for example, of recognition accuracy and performance, and system requirements specifications, the module selling site 103 may make a selection by filtering a number of candidate modules on the basis of such information.

Incidentally, in order to determine whether many candidate modules are retrieved by the search of the module registration information database 104, the online transaction system 100 may alternatively set a uniform threshold value or a buyer-specific threshold value that varies from one buyer to another (or varies from one application developer to another). Another alternative is to display a list of candidate modules on the module search screen of the buyer terminal 102, allow the buyer to determine each time whether there are many candidate modules, and trigger a narrowing-down procedure.

Further, the searches depicted in FIGS. 14 to 17 each include a similarity search. In a list of module search results, therefore, candidate modules exhibiting a relatively high degree of similarity are displayed in an upper position while candidate modules exhibiting a relatively low degree of similarity are displayed in a lower position. In addition, the range of the similarity search is determined by using, for example, a sliding parameter adjustment interface.

By performing a search in the module registration information database 104 through the module search screen depicted in FIGS. 14 to 17, the buyer is able to select the “(person detection) algo-C” module. Then, as indicated by a reference numeral 1801 in FIG. 18, the selected “(person detection) algo-C” module is added to the module search screen of the buyer terminal 102 and connected to the “xxx_camera” module through the camera/image interface. Further, on the basis of the registration information regarding the “person detection algo-C” module depicted in FIG. 6, the target_position interface is displayed on the output side of the “person detection algo-C” module as indicated by a reference numeral 1802 in FIG. 18.

It should be noted that, if the entity of the person detection algo-C module is a neural network, information regarding one or more files forming the entity of the module, such as network configuration files and learned weight parameters, is registered under “Files” within the module registration information (see FIG. 6). It is conceivable that the learned models generated by deep learning will be developed on an individual module basis such as a “person detection algo-C” module basis in an increasing number of situations and will frequently be updated.

It should be thoroughly understood that, as is obvious from FIGS. 13 to 18, the application developer is able to search for and select desired modules by performing a GUI operation through the module search screen and that module connections and data flows between connected modules are visualized on the module search screen.

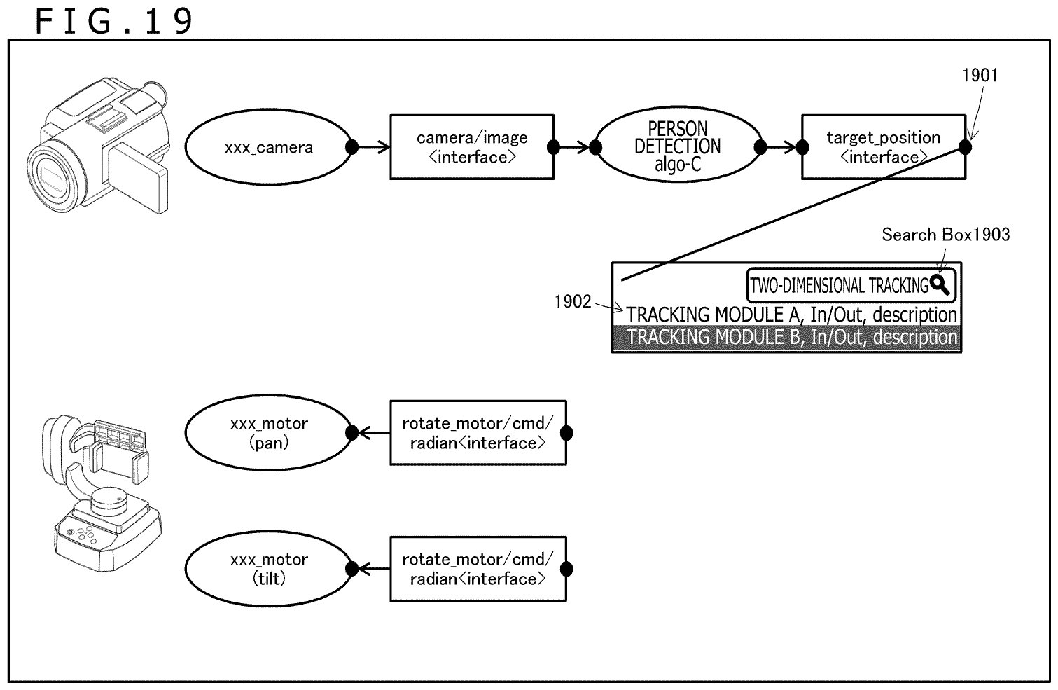

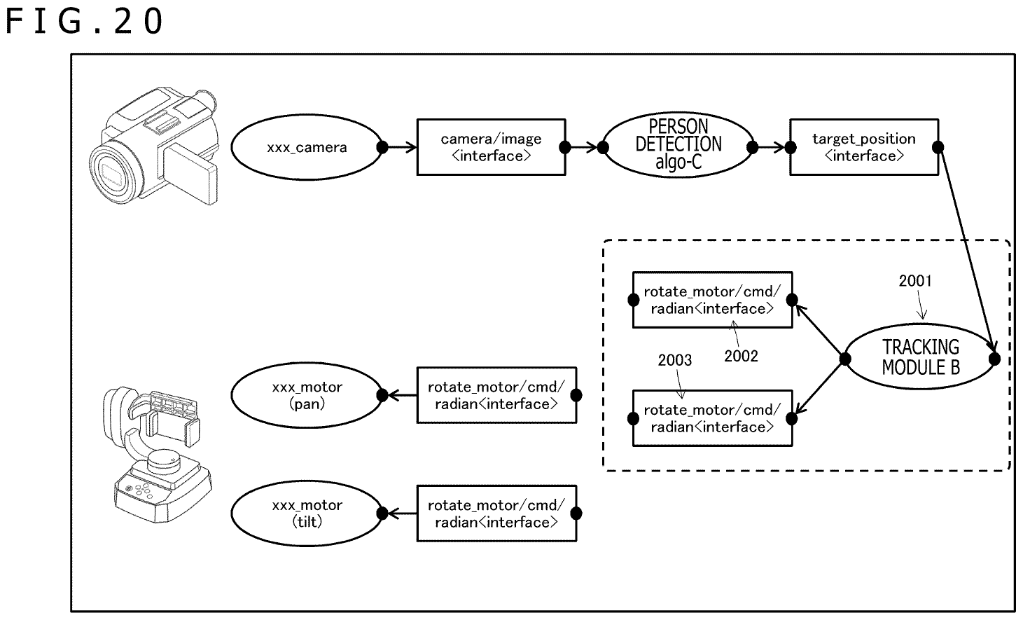

Next, the buyer clicks the output end of the target_position interface, which is denoted by a reference numeral 1901 in FIG. 19, on the module search screen of the buyer terminal 102. When such a click operation is reported from the buyer terminal 102, the module selling site 103 searches the module registration information database 104 for modules connectable to the target_position interface (or modules whose input is expressed by the target_position interface). In this instance, as the Class name of modules to be searched for, the buyer inputs “two-dimensional tracking” to the Search Box denoted by a reference numeral 1903. Then, the module selling site 103 searches the module registration information database 104 for modules that are connectable to the target_position interface and are in the Class named “two-dimensional tracking.” Next, as indicated by a reference numeral 1902 in FIG. 19, a list of modules retrieved by the search of the module registration information database 104 is displayed on the module search screen of the buyer terminal 102. The buyer is able to select one or more modules from the list of modules 1902. In the example depicted in FIG. 19, the buyer selects a “tracking module B” from the module list 1902.

It should be noted that, in a case where many candidates still belong to the Class, sub-class, and Targer designated by the buyer and the module registration information database 104 stores information regarding user review evaluations, results of evaluation, for example, of recognition accuracy and performance, and system requirements specifications, the module selling site 103 may make a selection by filtering a number of candidate modules on the basis of such information (same as above).

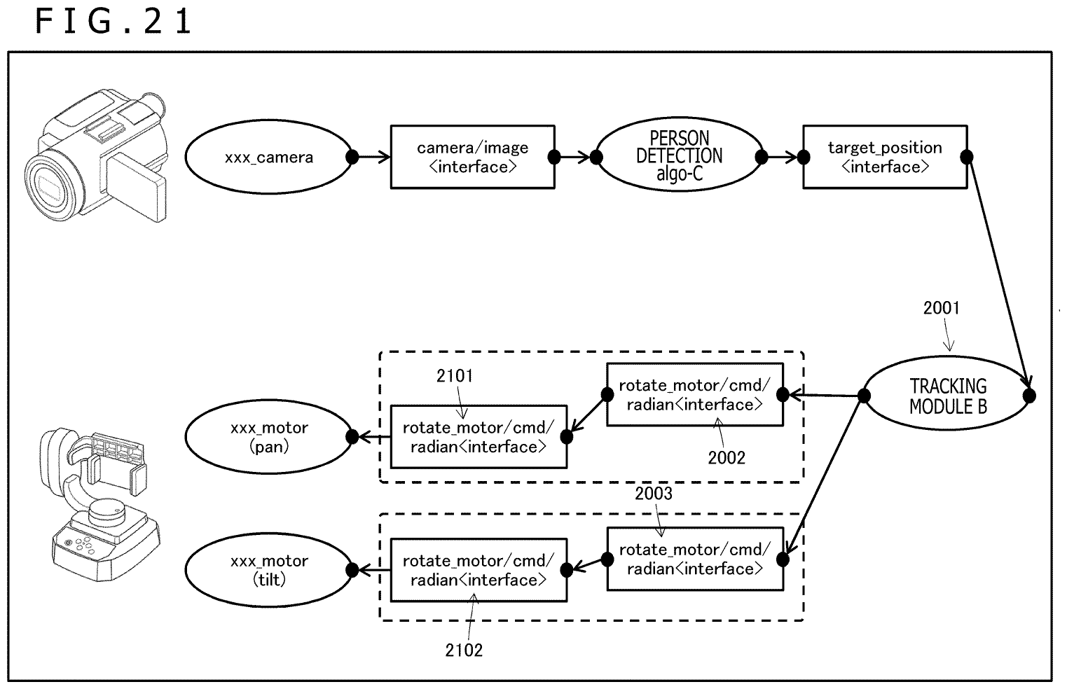

By performing a search in the module registration information database 104 through the module search screen depicted in FIGS. 18 and 19, the buyer is able to select the “tracking module B.” Then, as indicated by a reference numeral 2001 in FIG. 20, the selected “tracking module B” is added to the module search screen of the buyer terminal 102 and connected to the “person detection algo-C” module through the target_position interface. Further, as indicated by reference numerals 2002 and 2003 in FIG. 20, a rotate_motor/cmd/radian interface is displayed on an output side of the “tracking module B.”

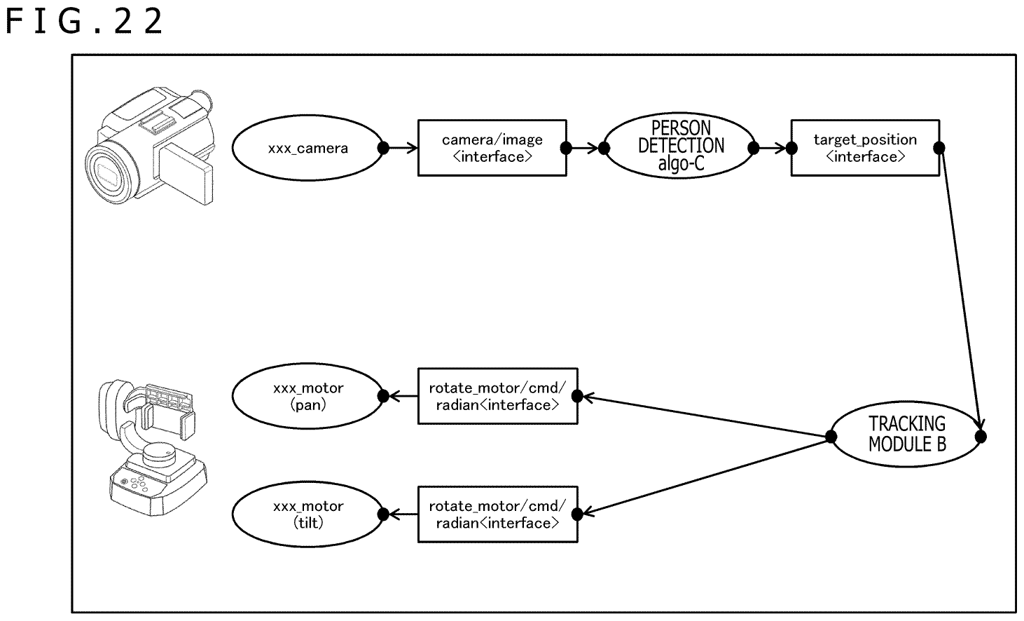

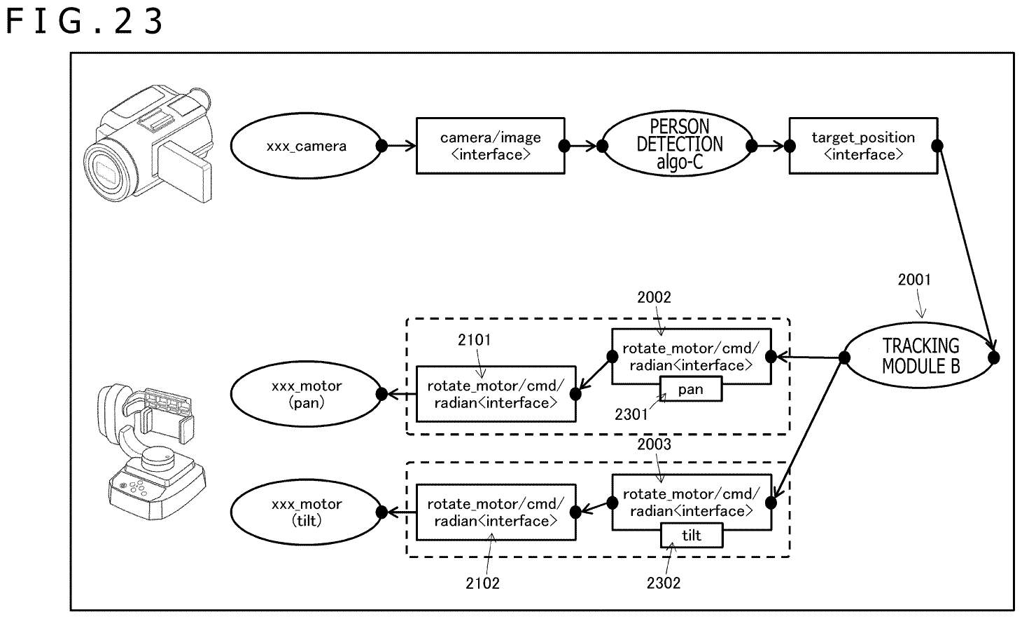

Next, as depicted in FIG. 21, earlier and later input/output states are verified between a rotate_motor/cmd/radian interface 2002 on one output side of the rotate_motor/cmd/radian “tracking module B” and a rotate_motor/cmd/radian interface 2101 on an input side of the xxx_motor module (rotating in the pan direction only). Similarly, the earlier and later input/output states are verified between a rotate_motor/cmd/radian interface 2003 on the other output side of the rotate_motor/cmd/radian “tracking module B” and a rotate_motor/cmd/radian interface 2102 on an input side of the xxx_motor module (rotating in the tilt direction only). Subsequently, identical rotate_motor/cmd/radian interfaces are integrated together as depicted in FIG. 22 if they are connected to content inconsistent in the earlier and later input/output states.

It can be said that FIG. 22 is drawn to visualize a developed application on the module search screen. The application depicted in FIG. 22 is used in the camera system 200 in order to detect a person in a camera image and track the detected person. In this instance, xxx_camera is a module for performing a process of acquiring an image from the digital camera 201, person detection algo-C is a module for performing a process of detecting a person in the image, the tracking module B is a module for performing a process of calculating a path for tracking a position where the person is detected in the image, and xxx_motor (pan) and xxx_motor (tilt) are modules for performing a process of driving the pan-tilt platform 202 along a predetermined path. Therefore, it is obvious from the flowchart depicted in FIG. 3 that a plurality of modules found necessary is searched for through the module search screen and combined to develop the application.

It should be noted that, as depicted in FIGS. 20 and 21, if “rotate_motor/cmd/radian” interfaces having the same name are encountered in a situation where the output interface of one module and the input interface of another module are to be integrated together for connecting the modules to each other, a problem arises which makes it impossible to identify whether pan or tilt is indicated by data. In order to avoid such a problem, the module registration information database 104 may be allowed to additionally register information regarding an alias (pseudonym) of each interface.

In the example depicted in FIG. 23, as indicated by a reference numeral 2301, “pan” is additionally registered as alias information regarding the rotate_motor/cmd/radian interface 2002 on one output side of the tracking module B. Similarly, as indicated by the reference numeral 2302, “tilt” is additionally registered as the alias information regarding the rotate_motor/cmd/radian interface 2003 on the other output side. In the above case, it is clear that the data regarding the one rotate_motor/cmd/radian interface 2002 is “pan” and should be integrated with the rotate_motor/cmd/radian interface 2101 on the side toward xxx_motor (pan) and that the data regarding the other rotate_motor/cmd/radian interface 2003 is “tilt” and should be integrated with the rotate_motor/cmd/radian interface 2102 on the side toward xxx_motor (tilt).

### C. Module Simulation and Operational Testing

The online transaction system 100 according to the present embodiment is configured such that the buyer is able to search for modules from the buyer's buyer terminal 102 via the module selling site 103 and combine multiple modules to achieve application development.

Here, the purpose of performing module simulation and operational testing in the processing sequence for online transaction of modules is to confirm, before buying modules, that an aggregate of modules combined as desired as a result of a module search (equivalent to a program) operates as expected by the user (or the module buyer or the application developer).

Module simulation and operational testing are roughly divided into two patterns, that is, a pattern in which test data is used and a pattern in which no test data is used.

C-1. Pattern in which Test Data is Used

In the pattern in which test data is used, the test data to be used for module simulation and operational testing is uploaded from the buyer terminal 102 to the module selling site 103.

The module selling site 103 executes the uploaded test pattern and returns the result of execution to the buyer terminal 102. The buyer terminal 102 receives and visualizes the result of execution.

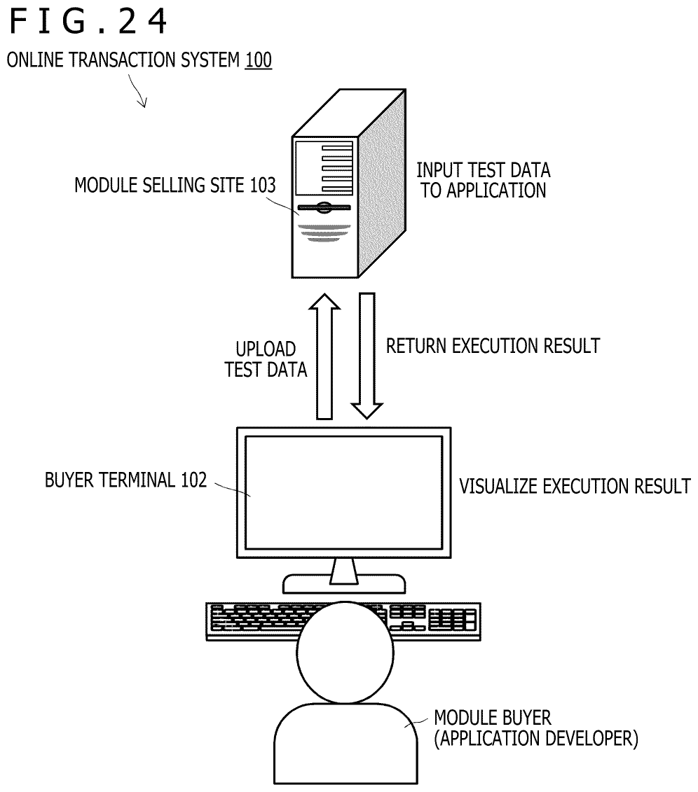

FIG. 24 illustrates the flow of data in a case where testing is performed on an application for detecting a person in a camera image and tracking the detected person. The buyer terminal 102 uploads test data which is to be inputted to the person detection algo-C module through the camera/image interface, to the module selling site 103. The module selling site 103 inputs the uploaded test data to a simulator that executes an application built by combining the person detection algo-C module with the tracking module B. Then, the module selling site 103 returns the result of simulation to the buyer terminal 102. The buyer terminal 102 receives and visualizes the result of execution.

On the basis of the visualized execution result of simulation and operational testing, the module buyer or the application developer is able to confirm whether the aggregate of modules combined on the module search screen, that is, a developed program, operates normally.

After confirming that the program operates normally, it is sufficient that the buyer proceeds to perform a procedure of buying the aggregate of modules at the buyer's buyer terminal 102. However, in a case where the program is not operating normally or is to be improved although it operates normally, the buyer may proceed to repeatedly perform a module search through the module search screen.

C-2. Pattern in which No Test Data is Used

Meanwhile, as a pattern in which no test data is used, two methods are available. One method is to test the modules on the actual machine, and the other method is to test the modules by simulation.

### C-2-1. Method of Testing Modules on Actual Machine

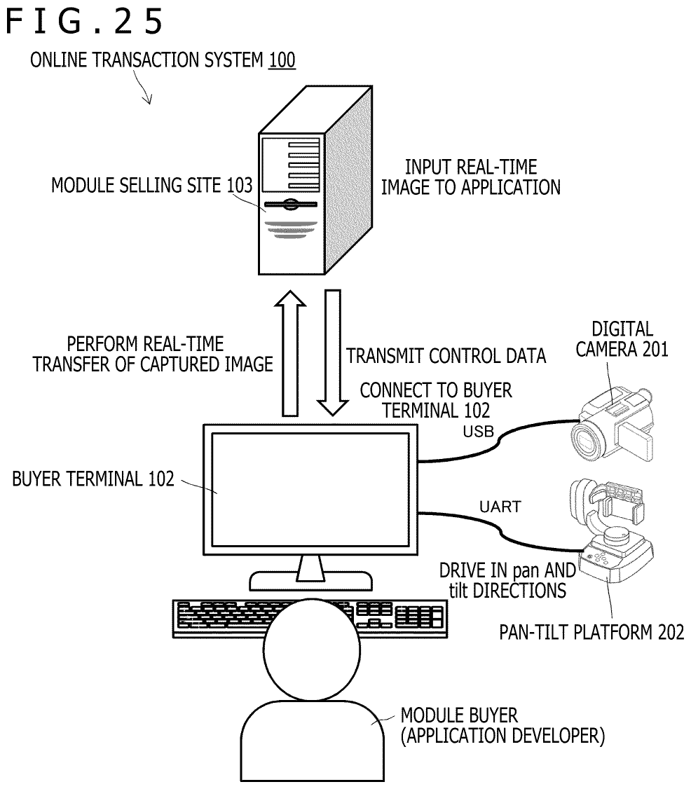

The method of testing the modules on the actual machine will now be described with reference to FIG. 25. The following description relates to an example in which testing is performed on an application for detecting a person in a camera image and tracking the detected person, as described above.

The digital camera 201 and the pan-tilt platform 202 are connected to the buyer terminal 102. Further, the digital camera 201 is mounted on the pan-tilt platform 202. Then, an image captured by the digital camera 201 is transferred on a real time basis from the buyer terminal 102 to the module selling site 103.

The application to be tested is operating at the module selling site 103. Then, the person detection algo-C module receives the transferred real-time image, inputs the real-time image through the camera/image interface, detects a person in the inputted real-time image, and outputs, from the target_position interface, a detection position where the person is detected. Subsequently, the tracking module B inputs data regarding the person detection position from the target_position interface, calculates individual control data for driving the pan-tilt platform 202 in each of the pan and tilt directions so as to track the movement of the person, outputs the calculated individual control data from the rotate_motor/cmd/radian interface, and from moment to moment, transmits, to the buyer terminal 102, the individual control data for driving the pan-tilt platform 202 in the pan and tilt directions.

On the basis of the individual control data received from the module selling site 103, the buyer terminal 102 drives the pan-tilt platform 202 in each of the pan and tilt directions. The buyer is able to visually or otherwise confirm whether the pan-tilt platform 202 is driven to vary the orientation of the digital camera 201 so as to let the image captured by the digital camera 201 track the person, that is, confirm whether a self-developed application is operating normally.

After confirming that the application operates normally, it is sufficient that the buyer proceeds to perform the procedure of buying the aggregate of modules at the buyer's buyer terminal 102. However, in a case where the program is not operating normally or is to be improved although it operates normally, the buyer may proceed to repeatedly perform a module search through the module search screen.

### C-2-2. Method of Testing Modules by Simulation

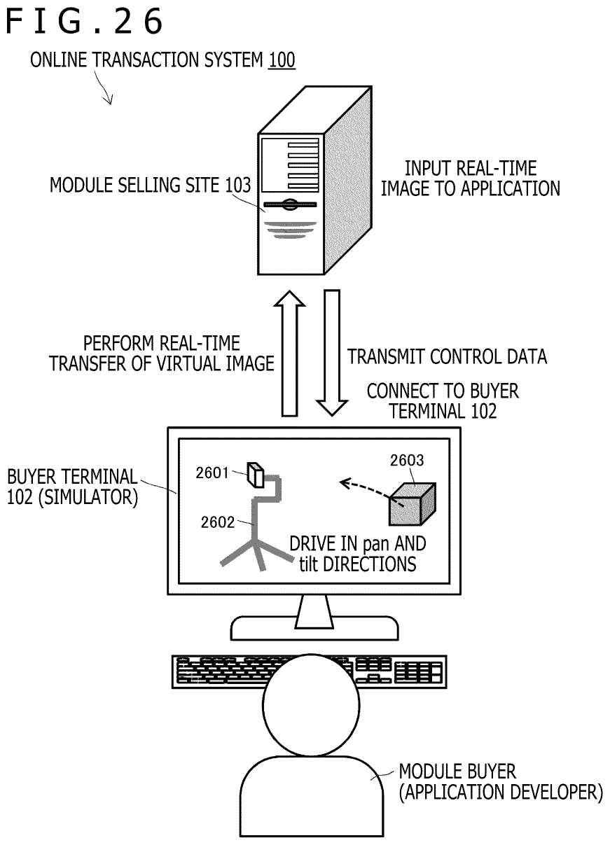

The method of testing the modules by simulation will now be described with reference to FIG. 26. The following description relates to an example in which the application is tested by using a simulator (virtual machine) that tracks a red cube in an image captured by a virtual camera mounted on a virtual platform.

A simulator for operating a virtual camera 2601 and a virtual platform 2602 is executed on the buyer terminal 102. Then, the buyer controls, for example, a mouse to move a red cube 2603 on a simulator screen (as a virtual person). The buyer terminal 102 transfers a virtual image captured by the virtual camera 2601 to the module selling site 103 on a real time basis.

The module selling site 103, which is running the application to be tested, receives the virtual image, detects the red cube in the received virtual image, calculates control data for driving the virtual platform so as to track the movement of the red cube, and from moment to moment, transmits the calculated control data to the buyer terminal 102.

The simulator, which is executed by the buyer terminal 102, drives the virtual platform 2602 on the basis of the control data received from the module selling site 103. The buyer viewing a simulation screen is able to confirm whether the virtual platform 2602 is driven to vary the orientation of the virtual camera 2601 so as to let the image captured by the virtual camera 2601 track the red cube 2603, that is, confirm whether the self-developed application is operating normally.

After confirming that the application operates normally, it is sufficient that the buyer proceeds to perform the procedure of buying the aggregate of modules at the buyer's buyer terminal 102. However, in a case where the program is not operating normally or is to be improved although it operates normally, the buyer may proceed to repeatedly perform a module search through the module search screen.

### D. Module Optimization and Compilation

Under normal conditions, the module selling site 103 builds a program by combining a plurality of modules and delivers the program to the buyer terminal 102.

However, in a case where a neural network is to be delivered on an individual module basis, it is necessary to perform optimization and compilation. For example, it is conceivable that the entity of the person detection algo-C module, which includes a person detection algorithm, may be a neural network (as mentioned earlier). For example, the following two algorithms may be used for module optimization and compilation.

(a) An algorithm for performing optimization to make modules operable rapidly with increased power savings by performing model compression on use-case dependent parameters used for processing.

(b) An algorithm for performing optimization to create a program configuration suitable for a processor at a delivery destination (e.g., a processor included in the single-board computer 203). The reason is that a wide variety of processors equipped with a hardware engine for executing a neural network are currently used.

The module selling site 103 may supply an interface for setting or adjusting algorithms (a) and (b) above to the buyer terminal 102. When performing a procedure of buying the modules, the buyer is able to set or adjust the optimization and compilation of the modules through the interface supplied from the module selling site 103.

More specifically, the buyer is able to connect a board equipped with a processor executing a developed application (e.g., the single-board computer 203) to the buyer terminal 102 through a USB or other connection interfaces and then set the processor with respect to the module selling site 103. Alternatively, the buyer may designate a processor from a pull-down menu displayed on the screen of the buyer terminal 102.

Further, on the basis of a designated combination of a buyer-specified processor configuration and a data type setting for parameter model compression (e.g., making sliding adjustments for 32 bits, 16 bits, 8 bits, 4 bits, 2 bits, or 1 bit; the adjustment target is not simply limited to the number of bits), the buyer is presented with a trade-off with at least one of processing speed, power consumption, or recognition accuracy. Then, the buyer is able to define the compilation information so as to optimize the modules by using the buyer-designed or automatically-selected optimum processor configuration information regarding the buyer's own use case and setting values of data types for model compression. It should be noted that the method used for model compression in a neural network is, for example, SVD (Singular Value Decomposition), network pruning (Pruning), quantization, Huffman encoding, or deep compression.

### E. System Extension

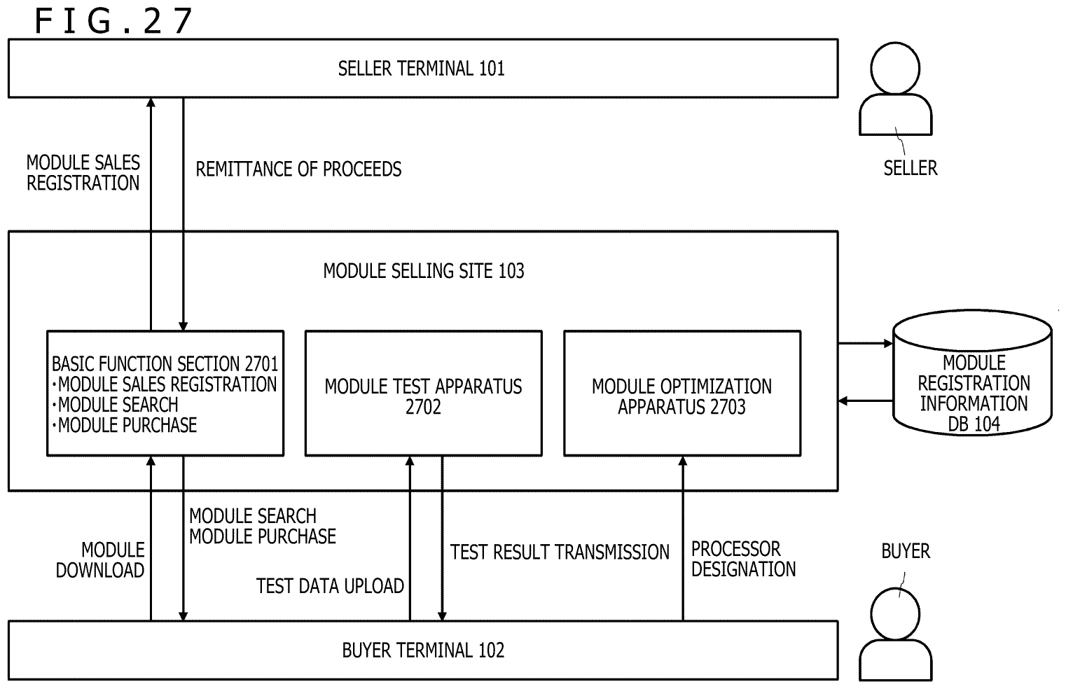

While FIG. 1 schematically illustrates an example configuration of the online transaction system 100, FIG. 27 illustrates an extended system configuration for implementing the functions described in B to D above.

Referring to FIG. 27, the module selling site 103 includes a basic function section 2701, a module test apparatus 2702, and a module optimization apparatus 2703. The basic function section 2701, the module test apparatus 2702, and the module optimization apparatus 2703 may be a plurality of physically independent apparatuses. Alternatively, at least any two of them may be combined and configured as a single apparatus.

The basic function section 2701 has functions of performing processes related to module sales registration, module search, and module purchase.

From the seller's own seller terminal 101, the module seller inputs the module registration information such as the input or output variables of modules to be sold on the module selling site 103, the functions of the modules, the effects of the modules, and the product identification information (in a case where the modules are dependent on a specific product). Then, within the module selling site 103, the basic function section 2701 registers the module registration information which is inputted through the seller terminal 101, in the module registration information database 104. Further, when the modules registered on the module selling site 103 are bought by the buyer (or when the bought modules are downloaded to the buyer terminal 102), the basic function section 2701 remits the proceeds of such sales to the seller terminal 101.

In an application development process, the module buyer inputs, to the buyer's own buyer terminal 102, information for module search, such as the input and output variables of necessary modules, the functions of the modules, the effects of the modules, and the product identification information (in a case where the modules are dependent on a specific product). On the basis of the information inputted to the buyer terminal 102, the basic function section 2701 searches for modules registered in the module registration information database 104, and then, the screen of the buyer terminal 102 presents the result of the search. It should be noted that the module buyer is able to successively select modules necessary for application development from the module search screen depicted, for example, in FIGS. 14 to 22 and combine a plurality of selected modules to develop an application. The processing procedure for such application development is as already explained. Further, the basic function section 2701 also performs a module buying procedure and downloads the modules bought by the buyer to the buyer's own buyer terminal 102.

Further, the module test apparatus 2702 has a function of simulating the operation of the module by using the test data.

The purpose of simulation is to confirm, before buying modules, whether the aggregate of the modules combined as desired by the buyer through a module search (equivalent to a program) operates as expected by the user (or the module buyer or the application developer). In this case, the test data to be used for module simulation and operational testing is uploaded from the buyer terminal 102 to the module selling site 103. The module test apparatus 2702 inputs the uploaded test data to the simulator, which executes the application developed by the buyer. Subsequently, the module test apparatus 2702 returns the result of simulation to the buyer terminal 102. The buyer terminal 102 visualizes the received result of execution.

The module optimization apparatus 2703 has a function of optimizing the program obtained by combining a plurality of modules selected by the buyer. This optimization function is exercised so as to create a program configuration suitable for a processor at a delivery destination (e.g., a processor included in the single-board computer 203).

The buyer connects a board equipped with a processor executing the developed application (e.g., the single-board computer 203) to the buyer terminal 102 through a USB or other connection interfaces and thus designates the processor. Alternatively, the buyer designates a processor from a pull-down menu displayed on the screen of the buyer terminal 102. Then, the module optimization apparatus 2703 optimizes the program obtained by combining a plurality of modules searched for by the basic function section 2701. The optimization is performed so as to create a program configuration suitable for the designated processor. It should also be noted that the program downloaded to the buyer terminal 102 by the basic function section 2701 is a binary program optimized by the module optimization apparatus 2703.

As a wide variety of processors equipped with a hardware engine for executing a neural network are currently used, it is important that program optimization be performed by the module optimization apparatus 2703.

### INDUSTRIAL APPLICABILITY

The technology disclosed in this document has been described in detail with reference to a specific embodiment. However, it is obvious that the above-described embodiment may be modified or changed by persons skilled in the art without departing from the spirit and scope of the technology disclosed in this document.

The online transaction system to which the technology disclosed in this document is applied makes it possible to perform a module search with ease and trade software on an individual module basis. Therefore, by using the online transaction system to which the technology disclosed in this document is applied, the application developer is able to search for modules and combine a plurality of modules to develop an application. In recent years, the deep learning technology is utilized in an increasing number of situations, and learned models generated by deep learning are developed on an individual module basis in an increasing number of situations and are frequently updated. Accordingly, great benefits are derived from the technology disclosed in this document because the technology makes it possible to handle the modules as a transaction target in an online marketplace.

In short, the technology disclosed in this document has been described in an illustrative manner, and the description given in this document should not be interpreted in a restrictive manner. The appended claims should be taken into consideration in order to define the spirit and scope of the technology disclosed in this document.

It should be noted that the technology disclosed is this document may also adopt the following configurations.

(1)

An information processing apparatus including:

a registration section that registers registration information in a database, the registration information including information regarding at least one of an input variable of a module, an output variable of the module, a function of the module, or an effect of the module; and

a search section that searches the database for a module having a related module function, on the basis of identification information regarding a product.

(2)

The information processing apparatus according to (1),

in which the registration section registers, in the database, the registration information received from a first terminal of a seller of a module.

(3)

The information processing apparatus according to (1) or (2),

in which the search section performs a search in the database on the basis of the identification information regarding the product and returns a result of the search to a second terminal of a buyer of a module, the identification information regarding the product being inputted to the second terminal of the buyer of the module.

(4)

The information processing apparatus according to (3),

in which the search section performs a search for candidate modules having an input variable common to an output variable of a module already searched for or candidate modules having an output variable common to an input variable of the module already searched for and presents the candidate modules to the second terminal.

(5)

The information processing apparatus according to (4),

in which the search section performs a search for candidate modules having a module function similar to a module function designated by the second terminal and presents the candidate modules to the second terminal.

(6)

The information processing apparatus according to (5),

in which the search section performs a module search on the second terminal on the basis of a similarity-degree search range that is parameter-adjusted in a sliding manner.

(7)

The information processing apparatus according to any one of (3) to (6), further including:

a supply section that builds an application from a plurality of modules and supplies the application to the second terminal, the plurality of modules being selected by the second terminal on the basis of the result of the search performed by the search section.

(8)

The information processing apparatus according to (7),

in which a first module is connected to a second module having an input variable common to an output variable of the first module after verifying earlier and later input/output states.

(9)

The information processing apparatus according to any one of (1) to (8),

in which the registration section further registers, in the database, alias information regarding at least one of the input variable or the output variable of the module.

(10)

The information processing apparatus according to any one of (3) to (9), further including:

a testing section that tests operation of an application that is built from a plurality of modules selected by the second terminal.

(11)

The information processing apparatus according to (10),

in which the testing section tests the operation of the application by using test data uploaded from the second terminal and returns a result of the test to the second terminal.

(12)

The information processing apparatus according to (10),

in which the testing section receives input data for the application from the second terminal, operates the application, and returns output data of the application to the second terminal.

(13)

The information processing apparatus according to any one of (1) to (12), further including:

an optimization section that optimizes a module selected by the second terminal.

(14)

The information processing apparatus according to (13),

in which the optimization section optimizes the module on the basis of configuration information regarding a processor designated by the second terminal.

(15)

The information processing apparatus according to (13) or (14),

in which the module includes a neural network module, and

the optimization section presents a trade-off with at least one of processing speed, power consumption, or recognition accuracy to the second terminal on the basis of a designated combination of setting values of data types for parameter model compression of the neural network module that is set by the second terminal.

(16)

An information processing method including:

a registration step of registering registration information in a database, the registration information including information regarding at least one of an input variable of a module, an output variable of the module, a function of the module, or an effect of the module; and

a search step of searching the database for a module having a related module function on the basis of identification information regarding a product.

(17)

An information processing apparatus including:

an input section that allows a user to input identification information regarding a product; and

a presentation section that presents a module having a related module function to the user, the module being searched for on the basis of the identification information regarding the product.

(17-1)

The information processing apparatus according to (17),

in which the identification information regarding the product inputted to the input section is transmitted to an external apparatus, and

the presentation section presents the module having the related module function, the module being searched for by the external apparatus on the basis of the identification information regarding the product.

(18)

The information processing apparatus according to (17),

in which the input section is able to further receive an input of a module function, and

the presentation section further presents candidate modules having a function similar to the module function inputted to the input section.

(18-1)

The information processing apparatus according to (18),

in which the presentation section presents candidate modules having an input variable common to an output variable of a module already searched for by an external apparatus or presents candidate modules having an output variable common to an input variable of the module already searched for by the external apparatus.

(18-2)

The information processing apparatus according to in (18),

in which the presentation section presents candidate modules having a module function similar to a module function designated by the second terminal, the candidate modules being searched for by an external apparatus.

(18-3)

The information processing apparatus according to (18),

in which the input section is able to receive an input of a module selected from candidate modules presented by the presentation section, and the selected module is reported to an external apparatus.

(19)

An information processing method including:

an input step of allowing a user to input identification information regarding a product; and

a presentation step of presenting a module having a related module function to the user, the module being searched for on the basis of the identification information regarding the product.

(20)

An information processing system including:

a selling apparatus that registers registration information in a database and performs processing related to selling of a module, the registration information including information regarding at least one of an input variable of the module, an output variable of the module, a function of the module, or an effect of the module; and

a buying apparatus that performs processing related to a user's buying of a module,

in which the selling apparatus searches the database for a module having a related module function, on the basis of product identification information inputted to the buying apparatus, and returns a result of the search to the buying apparatus, and

the buying apparatus presents, to the user, the module returned from the selling apparatus.

### REFERENCE SIGNS LIST

100 . . . Online transaction system, 101 . . . Seller terminal
102 . . . Buyer terminal, 103 . . . Module selling site
104 . . . Module registration information database
200 . . . Camera system, 201 . . . Digital camera
202 . . . Pan-tilt platform, 203 . . . Single-board computer
2701 . . . Basic function section, 2702 . . . Module test apparatus
2703 . . . Module optimization apparatus

1. An information processing apparatus comprising:
a registration section that registers registration information in a database, the registration information including information regarding at least one of an input variable of a module, an output variable of the module, a function of the module, or an effect of the module; and
a search section that searches the database for a module having a related module function, on a basis of identification information regarding a product.

2. The information processing apparatus according to claim 1,
wherein the registration section registers, in the database, the registration information received from a first terminal of a seller of a module.

3. The information processing apparatus according to claim 1,
wherein the search section performs a search in the database on a basis of the identification information regarding the product and returns a result of the search to a second terminal of a buyer of a module, the identification information regarding the product being inputted to the second terminal of the buyer of the module.

4. The information processing apparatus according to claim 3,
wherein the search section performs a search for candidate modules having an input variable common to an output variable of a module already searched for or candidate modules having an output variable common to an input variable of the module already searched for and presents the candidate modules to the second terminal.

5. The information processing apparatus according to claim 4,
wherein the search section performs a search for candidate modules having a module function similar to a module function designated by the second terminal and presents the candidate modules to the second terminal.

6. The information processing apparatus according to claim 5,
wherein the search section performs a module search on the second terminal on a basis of a similarity-degree search range that is parameter-adjusted in a sliding manner.

7. The information processing apparatus according to claim 3, further comprising:
a supply section that builds an application from a plurality of modules and supplies the application to the second terminal, the plurality of modules being selected by the second terminal on a basis of the result of the search performed by the search section.

8. The information processing apparatus according to claim 7,
wherein a first module is connected to a second module having an input variable common to an output variable of the first module after verifying earlier and later input/output states.

9. The information processing apparatus according to claim 1,
wherein the registration section further registers, in the database, alias information regarding at least one of the input variable or the output variable of the module.

10. The information processing apparatus according to claim 3, further comprising:
a testing section that tests operation of an application that is built from a plurality of modules selected by the second terminal.

11. The information processing apparatus according to claim 10,
wherein the testing section tests the operation of the application by using test data uploaded from the second terminal and returns a result of the test to the second terminal.

12. The information processing apparatus according to claim 10,
wherein the testing section receives input data for the application from the second terminal, operates the application, and returns output data of the application to the second terminal.

13. The information processing apparatus according to claim 1, further comprising:
an optimization section that optimizes a module selected by the second terminal.

14. The information processing apparatus according to claim 13,
wherein the optimization section optimizes the module on a basis of configuration information regarding a processor designated by the second terminal.

15. The information processing apparatus according to claim 13,
wherein the module includes a neural network module, and
the optimization section presents a trade-off with at least one of processing speed, power consumption, or recognition accuracy to the second terminal on a basis of a designated combination of setting values of data types for parameter model compression of the neural network module that is set by the second terminal.

16. An information processing method comprising:
a registration step of registering registration information in a database, the registration information including information regarding at least one of an input variable of a module, an output variable of the module, a function of the module, or an effect of the module; and
a search step of searching the database for a module having a related module function on a basis of identification information regarding a product.

17. An information processing apparatus comprising:
an input section that allows a user to input identification information regarding a product; and
a presentation section that presents a module having a related module function to the user, the module being searched for on a basis of the identification information regarding the product.

18. The information processing apparatus according to claim 17,
wherein the input section is able to further receive an input of a module function, and
the presentation section further presents candidate modules having a function similar to the module function inputted to the input section.

19. An information processing method comprising:
an input step of allowing a user to input identification information regarding a product; and
a presentation step of presenting a module having a related module function to the user, the module being searched for on a basis of the identification information regarding the product.

20. An information processing system comprising:
a selling apparatus that registers registration information in a database and performs processing related to selling of a module, the registration information including information regarding at least one of an input variable of the module, an output variable of the module, a function of the module, or an effect of the module; and
a buying apparatus that performs processing related to a user's buying of a module,
wherein the selling apparatus searches the database for a module having a related module function on a basis of product identification information inputted to the buying apparatus and returns a result of the search to the buying apparatus, and
the buying apparatus presents, to the user, the module returned from the selling apparatus.
